(19) United States
(12) Patent Application Publication
(10) Pub. No.: US 2020/0225022 A1
(43) Pub. Date: Jul. 16, 2020

(54) ROBOTIC 3D SCANNING SYSTEMS AND SCANNING METHODS

(71) Applicant: Guangdong Kang Yun Technologies Limited, Guangzhou City (CN)

(72) Inventor: Seng Fook Lee, Guangzhou City (CN)

(21) Appl. No.: 16/616,182

(22) PCT Filed: Jun. 15, 2018
(86) PCT No.: PCT/CN2018/091578

§ 371 Date: Nov. 22, 2019

Related U.S. Application Data
(60) Provisional application No. 62/584,135, filed on Nov. 10, 2017.

(51) Int. Cl. G01B 11/00; G01S 17/894

(52) U.S. Cl. CPC G01B 11/005; G01S 17/894

(57) ABSTRACT

A robotic 3D scanning system for scanning of an object comprising: a processor for determining an exact position for taking image shots of the object; a motion-controlling module comprising wheel(s) for moving from a current position to the exact position for taking the image shots; cameras for taking the image shots; a depth sensor for creating a point cloud of the object, the processor merges and processes the point cloud with the at least one image shot for generating a rendered map; and a self-learning module for reviewing a quality of the rendered map of the object in real-time, when the quality of the rendered map is not good then the self-learning module instructs the cameras to take an image shot of the object and the depth sensor to create a point cloud for rendering until a good quality rendered map comprising a 3D scanned image is generated.

### CROSS REFERENCE TO RELATED APPLICATIONS

This application is a national stage application under 35 U.S.C. 371 of PCT Application No. PCT/CN2018/091578, filed 15 Jun. 2018, which PCT application claimed the benefit of U.S. Provisional Patent Application No. 62/584,135, filed 10 Nov. 2017, the entire disclosure of each of which are hereby incorporated herein by reference.

### TECHNICAL FIELD

The presently disclosed embodiments relate to the field of imaging and scanning technologies. More specifically, embodiments of the present disclosure relate to robotic three-dimensional (3D) scanning systems and automatic 3D scanning methods for generating 3D scanned images of a plurality of objects and/or environment.

### BACKGROUND

A three-dimensional (3D) scanner may be a device capable of analysing environment or a real-world object for collecting data about its shape and appearance, for example, colour, height, length width, and so forth. The collected data may be used to construct digital three-dimensional models. Usually, 3D laser scanners create “point clouds” of data from a surface of an object. Further, in the 3D laser scanning, physical object's exact size and shape is captured and stored as a digital 3-dimensional representation. The digital 3-dimensional representation may be used for further computation. The 3D laser scanners work by measuring a horizontal angle by sending a laser beam all over the field of view. Whenever the laser beam hits a reflective surface, it is reflected back into the direction of the 3D laser scanner.

The existing 3D scanners or systems suffer from multiple limitations. For example, a higher number of pictures need to be taken by a user for making a 360-degree view. Also the 3D scanners take more time for taking or capturing pictures. Further, a stitching time is more for combining the more number of pictures (or images). Similarly, the processing time for processing the more number of pictures increases. Further, because of more number of pictures, the final scanned picture becomes heavier in size and may require more storage space. In addition, the user may have to take shots manually that may increase the user's effort for scanning of the objects and environment. Further, the present 3D scanner does not provide real-time merging of point clouds and image shots. Also a final product is presented to the user, there is no way to show intermediate process of rendering to the user. Further, in existing systems, some processor in a lab does the rendering of the object.

### SUMMARY

In light of above discussion, there exists need for better techniques for automatic scanning and primarily three-dimensional (3D) scanning of objects without any manual intervention. The present disclosure provides robotic systems and automatic scanning methods for 3D scanning of objects including at least one of symmetrical and unsymmetrical objects.

An objective of the present disclosure is to provide robotic 3D scanning systems and automatic scanning methods for providing self-reviewing or self-monitoring a quality of scanning/object rendering in real-time during the scanning process.

An objective of the present disclosure is to provide robotic 3D scanning systems and automatic scanning methods for self-reviewing or self-monitoring a quality of rendering and 3D scanning of an object in real-time so that one or more measures may be taken in real-time for enhancing a quality of the scanning/rendering in real-time.

Another objective of the present disclosure is to provide robotic 3D scanning systems and automatic scanning methods for real-time rendering of objects based self-reviewing or self-monitoring of rendering and scanning quality in real-time.

Another objective of the present disclosure is to provide robotic 3D scanning systems and automatic scanning methods for three-dimensional scanning and rendering of objects in real-time based on self-reviewing or self-monitoring of rendering and scanning quality in real-time. The one or more steps like re-scanning of the object may be done for enhancing a quality of the rendering of the object based in real-time.

A yet another objective of the present disclosure is to provide robotic 3D scanning systems and automatic scanning methods for self reviewing or self checking/learning a quality of scanning and rendering while processing of image shot with point clouds in real-time.

Another objective of the present disclosure is to provide a real-time self-learning module for 3D scanning system for 3D scanning of a plurality of an object. The self-learning module enables self-reviewing or self-monitoring to check an extent and quality of scanning in real-time while an image shot is being rendered with a point cloud of the object.

Another objective of the present disclosure is to provide robotic 3D scanning systems and automatic scanning methods for self-reviewing or self-monitoring of rendering and scanning quality in real-time while 3D rendering of a point cloud with an image shot is taking place. The system may take one or more steps for enhancing the scanning and rendering process for generating high quality 3D scanned image of an object.

Another objective of the present disclosure is to provide robotic 3D scanning system having a self-learning module and a depth sensor comprising an RGBD camera for scanning. The robotic 3D scanning system is capable of self-moving to exact positions for capturing at least one image shot. Further, the 3D scanning system self-reviews or self-monitors the rendering and scanning quality in real-time about the 3D scanning to monitor an extent and quality of scanning. The depth sensor or the RGBD camera may be configured to create a depth map or point cloud of an object. The depth map may be an image or image channel that contains information relating to the distance of the surfaces of scene objects from a viewpoint. Further, the point cloud may be a set of data points in some coordinate system. Usually, in a three-dimensional coordinate system, these points may be defined by X, Y, and Z coordinates, and may intend to represent an external surface of the object.

A yet another objective of the present disclosure is to provide a robotic 3D object scanning system having a depth sensor or an RGBD camera/sensor for creating a point cloud of the object. The point cloud may be merged and processed with a scanned image for creating a real-time rendering of the object. In some embodiments, the depth sensor may be at least one of a RGB-D camera, a Time-of-Flight (ToF) camera, a ranging camera, and a Flash LIDAR.

Another objective of the present disclosure is to provide a robotic 3D scanning system configured to self-review or self-monitor rendering and scanning quality in real-time while rendering is actually happening.

Another objective of the present disclosure is to provide a robotic 3D scanning system including a RGBD camera/sensor or a depth sensor for creating a point cloud of an object. The robotic 3D scanning system also includes a self-learning module for checking an extent of quality of a rendered map of the object generated by rendering in real-time. During a rendering process of the point cloud of the object, the system may take measure for improving quality of the rendering of object. Therefore, an effort and time for processing the point cloud and image shots for generating good quality scanned image may be reduced.

The present disclosure also provides robotic 3D scanning systems and methods for generating a good quality 3D model including scanned images of object(s) with a less number of images or shots for completing a 360-degree view of the object.

The present disclosure also provides a robotic system with self-learning module capable of reviewing the scanning and rendering process in real time.

The present disclosure provides robotic laser-guided coordinate systems and methods for advising an exact position to the user for taking one or more shots comprising one or more photos of an object one by one by self-determining an exact position.

The present disclosure also provides robotic 3D scanning systems and methods for generating a high quality three-dimensional (3D) scanned image of an object comprising a symmetrical and an unsymmetrical object or of an environment.

The present disclosure also provides robotic 3D scanning systems and methods for generating a 3D model including scanned images of object(s) by clicking a less number of images or shots for completing a 360-degree view of the object.

A further objective of the present disclosure is to provide a robotic laser guided co-ordinate system for advising taking image shots or photos or scan an object/environment.

Another objective of the present disclosure is to provide a robotic 3D scanning system for 3D scanning of objects and/or environment. The robotic 3D scanning system is configured to take a first shot and subsequent shots automatically. Further, the robotic 3D scanning system is configured to create point cloud of the objects.

Another objective of the present disclosure is to provide a self-moving robotic 3D scanning system for 3D scanning of objects.

A yet another objective of the present disclosure is to provide a self-moving system for scanning of objects by using laser guided technologies and self-learning capabilities.

Another objective of the present disclosure is to provide a robotic 3D scanning system for taking image shots and scanning of the object by self-reviewing a quality of the scanning process in real-time.

Another objective of the present disclosure is to provide a self-moving robotic 3D scanning system configured to scan 3D images of objects without any user intervention and user feedback.

A yet another objective of the present disclosure is to provide an automatic method for scanning or 3D scanning of at least one of symmetrical and unsymmetrical objects. The automatic method includes generating a point cloud of the object and capturing at leas tone image shot of the object. The point cloud and merged with the image shot for rendering of the object.

Another objective of the present disclosure is to provide a robotic system for generating at least one 3D model comprising a good quality scanned image of an object. The robotic system includes a self-learning module for self-reviewing the scanning and rendering of the object in real-time. The robotic system is capable of taking one or more steps for enhancing a quality of the scanning in real-time.

Another objective of the present disclosure is to provide a robotic 3D scanning system, which is self-moving and may move from one position to other for taking one or more shots of an object/environment. The robotic 3D scanning system may not require any manual intervention.

The present disclosure provides a robotic 3D system and method for taking a plurality of image shots of the object one by one from specific positions for completing a 360-degree view of the object. The robotic 3D system may determine specific positions from a first shot and move to the specific positions for taking the shots.

The present disclosure also provides robotic 3D scanning systems and automatic methods for generating a 3D model including scanned images of object(s) with a less number of images or shots for completing a 360-degree view of the object.

An embodiment of the present disclosure provides a robotic three-dimensional (3D) scanning system for scanning of an object, comprising: a processor configured to determine an exact position for taking one or more image shots of the object; a motion-controlling module comprising at least one wheel configured to enable a movement from a current position to the exact position for taking the one or more image shots one by one; one or more cameras configured to take the one or more image shots of the object for scanning; a depth sensor configured to create a point cloud of the object, wherein the first processor merges and processes the point cloud with the at least one image shot for generating a rendered map; and a self-learning module configured to review and check a quality of rendering and of the rendered map of the object in real-time, when the quality of the rendered map is not good then the self-learning module instructs the one or more cameras to take at least one image shot of the object and the depth sensor to create at least one point cloud for rendering of the object until a good quality rendered map comprising a 3D scanned image is generated.

Another embodiment of the present disclosure provides a robotic three-dimensional (3D) scanning system for 3D scanning of an object. The system includes a scanner comprising: a first processor for determining an exact position for taking each of one or more image shots of the object; a motion-controlling module comprising at least one wheel configured to enable a movement from a position to the exact position for taking the one or more image shots one by one; one or more cameras configured to take the one or more image shots of the object for scanning; a depth sensor configured to create a point cloud of the object; and a first transceiver configured to send the point cloud and the one or more image shots for further processing to a cloud network. The system also includes a rendering module in the cloud network, comprising: a second transceiver configured to receive the point cloud and one or more image shots from the scanner via the cloud network; a second processor configured to merge and process the received point cloud with the one or more image shots for rendering of the object and generating a rendered map; and a self-learning module. The self-learning module is configured to: review and check a quality of the rendered map of the object in real-time; and when the quality of the rendered map is not good then instructing the one or more cameras to take at least one image shot of the object and the depth sensor to create at least one point cloud for rendering of the object until a good quality of rendered map and a high quality 3D scanned image is not generated. The second transceiver may send the high quality 3D scanned image of the object to the scanner.

Another embodiment of the present disclosure provides a method for automatic three-dimensional (3D) scanning of an object, comprising: determining an exact position for taking one or more image shots of the object; moving from a current position to the exact position for taking one or more image shots of the object one by one; taking the one or more image shots of the object for scanning creating a point cloud of the object; creating a point cloud of the object; merging and processing the point cloud with the at least one image shot for generating a rendered map; self-reviewing and self-checking a quality of rendering and of the rendered map of the object in real-time; and when the quality of the rendered map is not good then instructing the one or more cameras to take at least one image shot of the object and the depth sensor to create at least one point cloud for rendering of the object until a good quality rendered map comprising a 3D scanned image is generated.

A further embodiment of the present disclosure provides an automatic method for 3D scanning of an object. The method at a scanner comprises: determining, by a first processor, an exact position for taking each of one or more image shots of the object; enabling, by a motion-controlling module comprising at least one wheel, a movement from a position to the exact position for taking the one or more image shots one by one; taking, by one or more cameras, the one or more image shots of the object for scanning; creating, by a depth sensor, a point cloud of the object; sending, by a first transceiver, the point cloud and the one or more image shots for further processing to a cloud network. Further, the method at a rendering module comprises: receiving, by a second transceiver, the point cloud and one or more image shots from the scanner via the cloud network; merging and processing, by a second processor, the received point cloud and the one or more image shots for rendering of the object and generating a rendered map; reviewing and checking, by a self-learning module, a quality of the rendered map of the object in real-time; when the quality of the rendered map is not good then instructing, by the self-learning module, the one or more cameras of the scanner to take at least one image shot of the object and the depth sensor of the scanner to create at least one point cloud for rendering of the object until a good quality of rendered map and a high quality 3D scanned image is not generated; and sending the high quality 3D scanned image of the object to the scanner.

According to an aspect of the present disclosure, the processor is configured to process the shots or images in real-time and hence in less time a 3D model may be generated.

According to another aspect of the present disclosure, t the depth sensor comprises at least one of a RGB-D camera, a Time-of-Flight (ToF) camera, a ranging camera, and a Flash LIDAR.

According to another aspect of the present disclosure, the one or more cameras takes the one or more shots of the object one by one based on the laser center co-ordinate and a relative width of the first shot.

According to a further aspect of the present disclosure, the robotic 3D scanning system includes a laser light configured to indicate the exact position by using a green color for taking the at least one shot.

According to an aspect of the present disclosure, a robotic 3D scanning system takes a first shot (i.e. N1) of an object and based on that, a laser center co-ordinate may be defined for the object.

According to an aspect of the present disclosure, for the second shot, the robotic 3D scanning system may provide a feedback about an exact position for taking the second shot (i.e. N2) and so on (i.e. N3, N4, and so forth). The robotic 3D scanning system may self move to the exact position and take the second shot and so on (i.e. the N2, N3, N4, and so on).

According to an aspect of the present disclosure, the robotic 3D scanning system may need to take few shots for completing a 360-degree view or a 3D view of the object or an environment.

According to another aspect of the present disclosure, the laser center co-ordinate is kept un-disturbed while taking the plurality of shots of the object.

According to another aspect of the present disclosure, the robotic 3D scanning system on a real-time basis processes the taken shots. In some embodiments, the taken shots and images may be sent to a processor in a cloud network for further processing in a real-time.

According to an aspect of the preset disclosure, the processor of the robotic 3D scanning system may define a laser center co-ordinate for the object from a first shot of the plurality of shots, wherein the processor defines the exact position for taking the subsequent shot without disturbing the laser center co-ordinate for the object based on a feedback.

According to another aspect of the present disclosure, the one or more cameras takes the plurality of shots of the object one by one based on the laser center co-ordinate and a relative width

According to another aspect of the present disclosure, the plurality of shots is taken one by one with a time interval between two subsequent shots.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIGS. 1A-1B illustrates exemplary environments where various embodiments of the present disclosure may function;

FIG. 2 is a block diagrams illustrating system elements of an exemplary robotic three-dimensional (3D) scanning system, in accordance with various embodiments of the present disclosure;

FIGS. 3A-3C illustrate a flowchart of a method for automatic three-dimensional (3D) scanning of an object by using the robotic 3D scanning system of FIG. 2, in accordance with an embodiment of the present disclosure; and

FIG. 4 is a block diagram illustrating system elements of a robotic 3D scanning system, in accordance with another embodiment of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). To facilitate understanding, like reference numerals have been used, where possible, to designate like elements common to the figures.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Reference throughout this specification to “a select embodiment”, “one embodiment” or “an embodiment” means that a particular feature, structure, or characteristic described in connection with the embodiment is included in at least one embodiment of the disclosed subject matter. Thus, appearances of the phrases “a select embodiment” “in one embodiment” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

All numeric values are herein assumed to be modified by the term “about,” whether or not explicitly indicated. The term “about” generally refers to a range of numbers that one of skill in the art would consider equivalent to the recited value (i.e., having the same or substantially the same function or result). In many instances, the terms “about” may include numbers that are rounded to the nearest significant figure. The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a,” “an,” and “the” include or otherwise refer to singular as well as plural referents, unless the content clearly dictates otherwise. As used in this specification and the appended claims, the term “or” is generally employed to include “and/or,” unless the content clearly dictates otherwise.

The following detailed description should be read with reference to the drawings, in which similar elements in different drawings are identified with the same reference numbers. The drawings, which are not necessarily to scale, depict illustrative embodiments and are not intended to limit the scope of the disclosure.

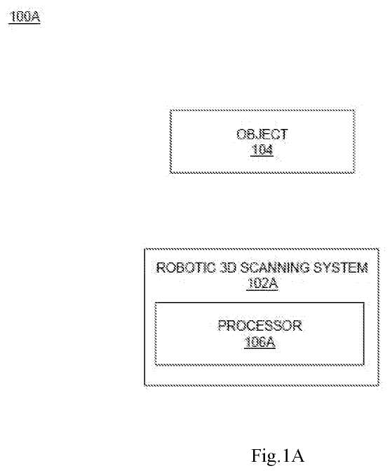

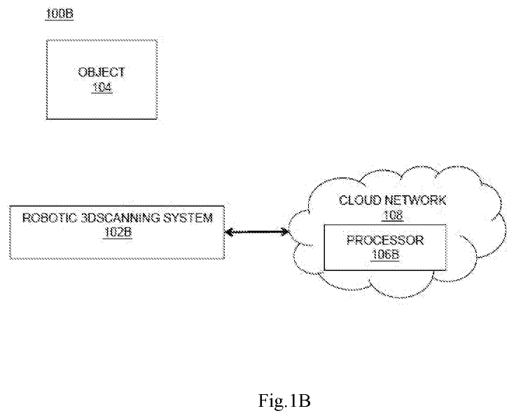

FIGS. 1A-1B illustrates an exemplary environments 100A-100B, respectively, where various embodiments of the present disclosure may function. As shown in FIG. 1A, the environment 100 primarily includes a robotic 3D scanning system 102A for scanning or 3D scanning of an object 104. The robotic 3D scanning system 102A may include a processor 106A. The object 104 may be a symmetrical object and an unsymmetrical object having uneven surface. Though only one object 104 is shown, but a person ordinarily skilled in the art will appreciate that the environment 100 may include more than one object 104.

The robotic 3D scanning system 102A is configured to determine an exact position for capturing one or more image shots of an object. The robotic 3D scanning system 102A is configured may be a self-moving device comprising at least one wheel. The robotic 3D scanning system 102A is capable of moving from a current position to the exact position. The robotic 3D scanning system 102A comprising a depth sensor such as an RGBD camera is configured to create a point map of the object 104. The point cloud may be a set of data points in some coordinate system. Usually, in a three-dimensional coordinate system, these points may be defined by X, Y, and Z coordinates, and may intend to represent an external surface of the object 104.

Further, the robotic 3D scanning system 102A is configured to capture one or more shots including images of the object 104 for generating a 3D model including at least one image of the object 104. In some embodiments, the robotic 3D scanning system 102A is configured to capture less number of images of the object 104 for completing a 360-degree view of the object 104. Further, in some embodiments, the robotic 3D scanning system 102A may be configured to generate 3D scanned models and images of the object 104. In some embodiments, the robotic 3D scanning system 102A may be a device or a combination of multiple devices, configured to analyse a real-world object or an environment and may collect/capture data about its shape and appearance, for example, colour, height, length width, and so forth. The robotic 3D scanning system 102A may use the collected data to construct a digital three-dimensional model.

In some embodiments, the processor 106A may indicate an exact position to take one or more shots or images of the object 104. For example, the robotic 3D scanning system 102A may point a green color light to the exact position for taking a number of shots of the object 104 one by one. For taking each of the shots, the robotic 3D scanning system 102A points a green light to an exact position from where the next shot of the object 104 should be taken. In some embodiments, the robotic 3D scanning system 102A includes a laser light configured to switch from a first color to a second color to indicate or signal an exact position for taking a number of shots including at least one image of the object 104. In some embodiments, the first color may be a red color and the second color may be a green color.

Further, the processor 106A may define a laser center co-ordinate for the object 104 from a first shot of the shots. Further, the robotic 3D scanning system 102A may define the exact position for taking the subsequent shot without disturbing the laser center co-ordinate for the object. The exact position for taking the subsequent shot is defined without disturbing the laser center co-ordinate for the object 104. Further, the robotic 3D scanning system 102A is configured to define a new position co-ordinate of the based on the laser center co-ordinate and the relative width of the shot. The robotic 3D scanning system 102A may be configured to self-move to the exact position to take the one or more shots of the object 104 one by one based on an indication or the feedback. In some embodiments, the robotic 3D scanning system 102A may take subsequent shots of the object 104 one by one based on the laser center co-ordinate and a relative width of a first shot of the shots. Further, the subsequent one or more shots may be taken one by one after the first shot. For each of the one or more, the robotic 3D scanning system 102A may point a green laser light on an exact position or may provide feedback about the exact position to take a shot. Furthermore, the robotic 3D scanning system 102A may capture multiple shots for completing a 360-degree view of the object 104. Furthermore, the robotic 3D scanning system 102A may stitch and process the multiple shots to generate at least one 3D model including a scanned image of the object 104.

Further, the processor 106A may be configured to process the image shots in real-time. This may save the time required for generating the 3D model or 3D scanned image. The robotic 3D scanning system 102A may merge and process the point cloud and the one or more shots for rendering of the object 104. The robotic 3D scanning system 102A may self-review and monitor a quality of a rendered map of the object 104. If the quality is not good, the robotic 3D scanning system 102A may take one or more measures like re-scanning the object 104.

The robotic 3D scanning system 102A may include wheels for self-moving to the exact position. Further, the robotic 3D scanning system 102A may automatically stop at the exact position for taking the shots. Further, the robotic 3D scanning system 102A may include one more arms including at least one camera for clicking the images of the object 104. The arms may enable the cameras to capture shots precisely from different angles. In some embodiments, a user (not shown) may control movement of the robotic 3D scanning system 102A via a remote controlling device or a mobile device like a phone.

In some embodiments, the robotic 3D scanning system 102A doesn't include the processor 106A. FIG. 1B shows a robotic 3D scanning system 102B without the processor 106A. In such embodiments, the processor, such as a processor 106B, may be present in a cloud network 108. The robotic 3D scanning system 102B may send the point cloud and the one or more image shots to the processor 106B in the cloud network 108 for further processing and may receive the result of rendering and scanning. The processor 106B may send a feedback regarding a quality of rendering and scanning to the robotic 3D scanning system 102B. The robotic 3D scanning system 102B may re-scan or re-take more image shots comprising images of missing parts of the object 104 and send the same to the processor 106B. The processor 106B may again check the quality of rendering and if quality is ok then the processor 106B may generate a good quality 3D scanned image. The processor 106B may send the good quality to the robotic 3D scanning system 102B for saving or for presenting to a user (not shown).

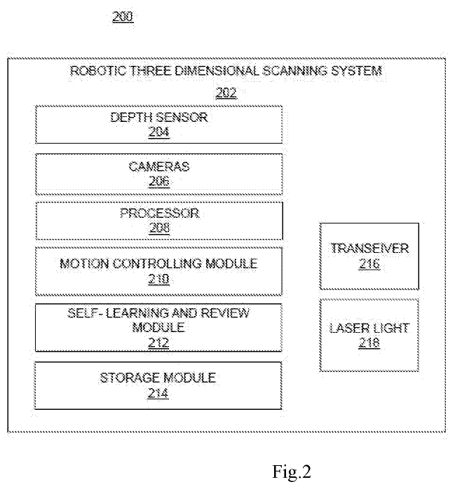

FIG. 2 is a block diagram 200 illustrating system elements of an exemplary robotic 3D scanning system 202, in accordance with various embodiments of the present disclosure. As shown the robotic 3D scanning system 202 primarily including a depth sensor 204, one or more cameras 206, a processor 208, a motion controlling module 210, a self-learning module 212, a storage module 214, a transceiver 216, and a laser light 218. As discussed with reference to FIGS. 1A-1B, the robotic 3D scanning system 202 may be configured to capture or scan 3D images of the object 104. In some embodiments, the robotic 3D scanning system 202 may include only one of the cameras 206.

The depth sensor 204 is configured to create a point cloud of an object, such as the object 104 of FIG. 1. The point cloud may be a set of data points in a coordinate system. In a three-dimensional coordinate system, these points may be defined by X, Y, and Z coordinates, and may intend to represent an external surface of the object 104. The depth sensor 204 may be at least one of a RGB-D camera, a Time-of-Flight (ToF) camera, a ranging camera, and a Flash LIDAR.

The processor 208 may be configured to identify an exact position for taking one or more shots of the object 104. In some embodiments, the exact position may be as specified by the laser light 218 of the robotic 3D scanning system 202. The laser light 218 may point a green light on the exact position.

The motion-controlling module 210 may move the robotic 3D scanning system 202 from a position to the exact position. The motion-controlling module 210 may include at least one wheel for enabling movement of the robotic 3D scanning system 202 from one position to other. In some embodiments, the motion-controlling module 210 includes one or more arms comprising the cameras 206 for enabling the cameras to take image shots of the object 104 from different angles for covering the object 104 completely. In some embodiment, the motion-controlling module 210 comprises at least one wheel is configured to enable a movement of the robotic 3D scanning system 202 from a current position to the exact position for taking the one or more image shots of the object 104 one by one.

The cameras 206A-206C may be configured to take one or more image shots of the object 104. Further, the one or more cameras 206A-206C may be configured to capture the one or more shots of the object 104 one by one based on the exact position. In some embodiments, the cameras 206 may take a first shot and the one or more shots of the object 104 based on a laser center coordinate and a relative width of the first shot such that the laser center coordinate remains undisturbed while taking the plurality of shots of the object 104. Further, the 3D scanning system 202 includes the laser light 218 configured to indicate an exact position for taking a shot by pointing a specific colour such as a green colour, light to the exact position.

The processor 208 may also be configured to render the object 104 in real-time by merging and processing the point cloud with the one or more image shots for generating a 3D scanned image. The processor 208 merges and processes the point cloud with the at least one image shot for generating a rendered map.

The self-learning module 212 may review or monitor/check a quality of the scanning or rendering of the object 104 or of a rendered map of the object 104 in real time. Further when the quality of the scanning/rendered map is not good, then the self-learning module 212 may instruct the cameras 206 to capture at least one image shot and may instruct the depth sensor 204 to create at least one point cloud until for rendering of the object a good quality rendered object comprising a high quality 3D scanned object is generated.

The storage module 214 may be configured to store the images, rendered images, rendered maps, instructions for scanning and rendering of the object 104, and 3D models. In some embodiments, the storage module 214 may be a memory.

The transceiver 216 may be configured to send and receive data, such as image shots, point clouds etc., to/from other devices via a network including a wireless network and a wired network. Further, the laser light 218 may be configured to indicate the exact position by using a green color for taking the at least one shot.

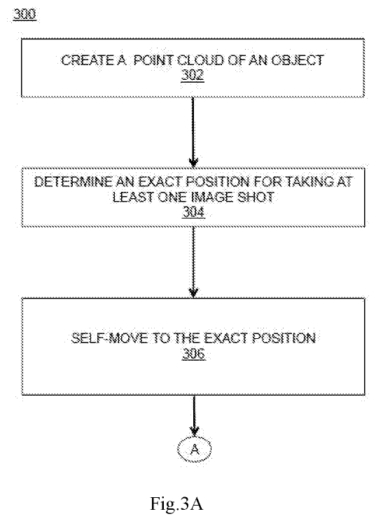

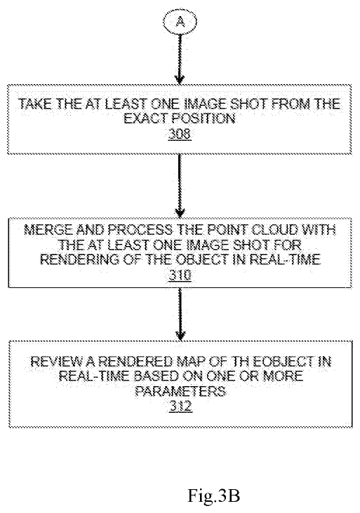

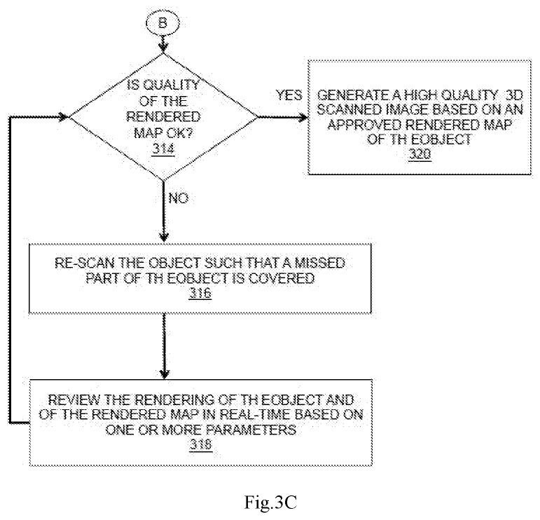

FIGS. 3A-3C illustrate a flowchart of a method 300 for automatic three-dimensional (3D) scanning of an object by using the robotic 3D scanning system of FIG. 2, in accordance with an embodiment of the present disclosure.

At step 302, a depth sensor of a robotic 3D scanning system creates a point cloud of the object. At step 304, an exact position for taking at least one image shot is determined. Then at step 306, the robotic 3D scanning system moves from a current position to the exact position. Then at step 308, one or more cameras of the robotic 3D scanning system takes the at least one image shot of the object. The object may be a symmetrical object or an unsymmetrical object.

Then at step 310, the point cloud and the at least one image shot are merged and processed for generating a rendered map. At step 312, the rendered map is self-reviewed and monitored by a self-learning module of the robotic 3D scanning system for checking a quality of the rendered map. Then at step 314, it is checked if the quality of the rendered map is ok or not. If No at step 314 then process control goes to step 316 else a step 320 is executed. At step 316, the object is re-scanned by the one or more cameras such that a missed part of the object is scanned properly. Thereafter at step the rendering of the object is again reviewed in real-time based on one or more parameters such as, but not limited to, machine vision, stitching extent, texture extent, and so forth.

If yes at step 314, then at step 320, a high quality 3D scanned image of the object is generated from the approved rendered map of the object. In some embodiments, a processor may generate the high quality 3D scanned image of the object.

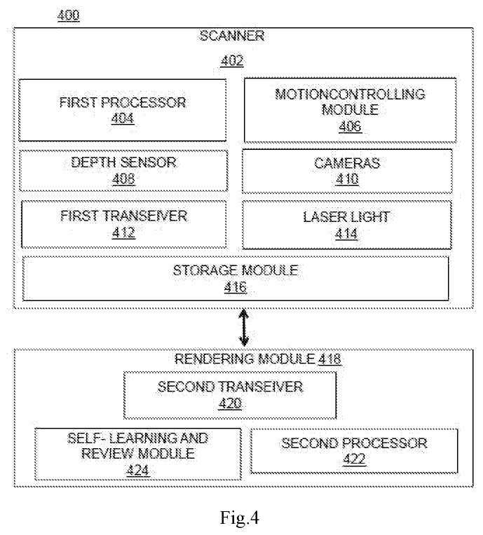

FIG. 4 is a block diagram illustrating system elements of an exemplary robotic 3D scanning system 400 according to an embodiment of the present disclosure. As shown, the robotic 3D scanning system 400 includes a scanner 402 and a rendering module 418. The scanner 402 includes a first processor 404, a motion-controlling module 406, a depth sensor 408, one or more cameras 410, a first transceiver 412, a laser light 414, and a storage module 416. The rendering module 418 includes a second transceiver 420, a second processor 422, and a self-learning module 424.

The first processor 404 is configured to determine an exact position for taking each of one or more image shots of the object. The exact position for taking each of one or more shots \is defined based on a laser center co-ordinate and a relative width of a first shot. An exact position for taking the subsequent shot may be defined without disturbing the laser center co-ordinate for the object 104. In some embodiments, the laser light 414 may indicate the exact positing by pointing a green color light to the exact position. The motion-controlling module 406 includes at least one wheel and is configured to enable a movement from a position to the exact position for taking the one or more image shots one by one. The depth sensor 408 is configured to create a point cloud of the image. The depth sensor 408 may include at least one of a RGB-D camera, a Time-of-Flight (ToF) camera, a ranging camera, and a Flash LIDAR.

The one or more cameras 410 are configured to take the one or more image shots of the object for scanning. The image shots may be taken from different angles with respect to the object such that taking a 360-degree view of the object. The storage module 416 may store the image shots, point clouds, rendered maps, and so forth. The first transceiver 412 is configured to send the point cloud and the one or more image shots for further processing to the rendering module 418 in a cloud network.

The second receiver 420 configured to receive the point cloud and one or more image shots from the scanner 402 via the cloud network. The second processor 422 is configured to merge and process the received point cloud with the one or more image shots for rendering of the object and generating a rendered map.

The self-learning module 424 is configured to review and check a quality or an extent of quality of the rendered map of the object in real-time. Further, when the quality of the rendered map is not good then instructing the one or more cameras 410 to take at least one image shot of the object and the depth sensor 408 to create at least one point cloud for rendering of the object until a good quality of rendered map and a high quality 3D scanned image is not generated. Then the second processor 422 is configured to merge and processes the at least one point cloud with the at least one image shot for generating a new rendered map. This process may be repeated until a good quality rendered map or a 3D scanned image is generated.

Further, the second transceiver 420 may send the high quality 3D scanned image of the object to the scanner 402.

The first transceiver 412 may receive the high quality 3D scanned image of the object and save the same in the storage module 416. In some embodiments, the 3D scanned image may be presented to a user on a display screen.

The present disclosure provides a robotic 3D object scanning system including a depth sensor such as RGB-D camera for creating a point cloud of the object. The point cloud are merged with scanned images i.e. the one or more image shots to create a real-time rendering of the object. This real-time rendered mapping of the object is sent to self-learning machine module for review. The self-learning machine module may review the rendered map based on various parameters such as machine vision, stitching extent, texture extent, and so forth. The self-learning machine module may pass or approve the rendered map based on analysis or may instruct the cameras to re-scan the missing part of the object. The re-scanned rendered map may again be reviewed and may pass through self-learning machine module. The steps of re-scanning and review are repeated until the self-learning machine module approves the rendered map.

In some embodiments, the robotic 3D scanning system (or scanner of FIG. 4) sends the point clouds and image shots to a processor (or the rendering module of FIG. 4) in the cloud network and may receive the instructions for re-scanning when the rendered map is not good quality as per the parameters. The self-learning module is in the processor in the cloud network. The self-learning module may check the quality of the rendered map and may instruct the depth sensor and the cameras to send point clouds and image shots again for processing. The processor may generate the 3D scanned images based on an approved rendered map and send back to the robotic 3D scanning system.

The system disclosed in the present disclosure enables real-time visual feedback of scanning and rendering.

The system disclosed in the present disclosure also provides better scanning of the objects. Further, the system provides better stitching while processing of the point clouds and image shots. The system results in 100% mapping of the object, which in turn results in good quality scanned image(s) of the object without any missing parts.

The system disclosed in the present disclosure produces scanned images with less error rate and provides 3D scanned images in less time.

Embodiments of the disclosure are also described above with reference to flowchart illustrations and/or block diagrams of methods and systems. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks. These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the acts specified in the flowchart and/or block diagram block or blocks.

In addition, methods and functions described herein are not limited to any particular sequence, and the acts or blocks relating thereto can be performed in other sequences that are appropriate. For example, described acts or blocks may be performed in an order other than that specifically disclosed, or multiple acts or blocks may be combined in a single act or block.

While the invention has been described in connection with what is presently considered to be the most practical and various embodiments, it is to be understood that the invention is not to be limited to the disclosed embodiments, but on the contrary, is intended to cover various modifications and equivalent arrangements.

What is claimed is:

1. A robotic three-dimensional (3D) scanning system for scanning of an object, comprising:
a processor configured to determine an exact position for taking one or more image shots of the object;
a motion-controlling module comprising at least one wheel configured to enable a movement from a current position to the exact position for taking the one or more image shots of the object one by one;
one or more cameras configured to take the one or more image shots of the object for scanning;
a depth sensor configured to create a point cloud of the object, wherein the processor merges and processes the point cloud with the at least one image shot for generating a rendered map; and
a self-learning module configured to review and check a quality of scanning of the rendered map of the object in real-time, when the quality of the rendered map is not good then the self-learning module instructs the one or more cameras to take at least one image shot of the object and the depth sensor to create at least one point cloud for rendering of the object until a good quality rendered map comprising a 3D scanned image is generated.

2. The robotic three-dimensional scanning system of claim 1, wherein the depth sensor comprises at least one of a RGB-D camera, a Time-of-Flight (ToF) camera, a ranging camera, and a Flash LIDAR.

3. The robotic three-dimensional scanning system of claim 1 further comprising a laser light configured to indicate the exact position by using a green color for taking at least one shot.

4. A robotic three-dimensional (3D) scanning system for 3D scanning of an object, comprising:
a scanner comprising:
a first processor configured to determine an exact position for taking each of one or more image shots of the object;
a motion-controlling module comprising at least one wheel configured to enable a movement from a position to the exact position for taking the one or more image shots one by one;
one or more cameras configured to take the one or more image shots of the object for scanning;
a depth sensor configured to create a point cloud of the object; and
a first transceiver configured to send the point cloud and the one or more image shots for further processing to a cloud network;
a rendering module in the cloud network, comprising:
a second transceiver configured to receive the point cloud and one or more image shots from the scanner via the cloud network;
a second processor configured to merge and process the received point cloud with the one or more image shots for rendering of the object and generating a rendered map; and
a self-learning module configured to:
review and check a quality of the rendered map of the object in real-time; and
when the quality of the rendered map is not good then instructing the one or more cameras to take at least one image shot of the object and the depth sensor to create at least one point cloud for rendering of the object until a good quality of rendered map and a high quality 3D scanned image is not generated;
wherein the second transceiver sends the high quality 3D scanned image of the object to the scanner.

5. The robotic three-dimensional scanning system of claim 4, wherein the depth sensor comprises at least one of a RGB-D camera, a Time-of-Flight (ToF) camera, a ranging camera, and a Flash LIDAR.

6. The robotic three-dimensional scanning system of claim 4 further comprising a laser light configured to indicate the exact position by using a green color for taking the at least one shot.

7. A method for automatic three-dimensional (3D) scanning of an object, comprising:
determining an exact position for taking one or more image shots of the object;
moving from a current position to the exact position for taking one or more image shots of the object one by one;
taking the one or more image shots of the object for scanning creating a point cloud of the object;
creating a point cloud of the object;
merging and processing the point cloud with the at least one image shot for generating a rendered map;
self-reviewing and self-checking a quality of rendering and of the rendered map of the object in real-time; and
when the quality of the rendered map is not good then instructing the one or more cameras to take at least one image shot of the object and the depth sensor to create at least one point cloud for rendering of the object until a good quality rendered map comprising a 3D scanned image is generated.

8. The method of claim 7, wherein the depth sensor comprises at least one of a RGB-D camera, a Time-of-Flight (ToF) camera, a ranging camera, and a Flash LIDAR.

9.-11. (canceled)
